(19) United States
(12) Patent Application Publication
(10) Pub. No.: US 2025/0303528 A1
(43) Pub. Date: Oct. 2, 2025

(54) RECONFIGURABLE TURNING TOOL

(71) Applicant: Klein Tools, Inc., Lincolnshire, IL (US)

(72) Inventors: James E. Murphy, Bartonville, TX (US); Gregory Andi, Arlington, TX (US); Jonathan Low, Fort Worth, TX (US); Tye Parker, Southlake, TX (US)

(73) Assignee: Klein Tools, Inc., Lincolnshire, IL (US)

(21) Appl. No.: 18/625,054

(22) Filed: Apr. 2, 2024

(51) Int. Cl. B25B 13/48; B25B 13/50; B25B 23/00

(52) U.S. Cl. CPC B25B 13/481; B25B 23/0035; B25B 13/5091

(57) ABSTRACT

A reconfigurable tool for turning components with different configurations has: a) a base with a body having a turning axis, axially spaced first and second ends, and a wall extending around the turning axis; and b) a first tool part having spaced ends and a first engaging part at one of the spaced ends that is configured to be operatively positioned with respect to a component with a first configuration. The base body and first tool part are configured so that the base body and first tool part can be: a) placed in a first starting relationship with the first tool part in radially spaced and axially overlapping relationship with the base body; and b) moved towards each other transversely to the turning axis from the first starting relationship into a first connected relationship, whereupon movement of the base body around the turning axis causes the first tool part to turn the component relative to which the first engaging portion is operatively positioned.

### BACKGROUND OF THE INVENTION

### Field of the Invention

This invention relates to reconfigurable tools and, more particularly, to a tool that can be reconfigured to be operatively positioned with respect to different forms and sizes of components, to facilitate turning thereof. In some preferred embodiments, the tool is particularly adapted for use as a plumbing tool in connection with installing and repairing of basins, faucets, etc.

### Background Art

Reconfigurable hand tools are used commonly worldwide. There are many associated advantages that can be realized by those in various trades as well as by persons working on personal projects. Most notably, a single reconfigurable tool may take the place of a number of dedicated tools.

On many projects, persons can generally anticipate the types of tools that will be necessary to turn different components. However, the various components on which tools must be used to assist turning thereof may vary considerably in terms of shape and dimension. Thus, professionals will commonly carry sets of the same type of tools, which creates inconvenience in terms of managing multiple dedicated tools and presents the challenges of keeping track of many tools and readily accessing the particular tool needed.

Plumbers commonly work on sinks and accessories through an undercounter access. Within the particular volume in which they operate, they may have to turn valve handles, turn nuts with different sizes and configurations, install and remove strainers, connect and disconnect water supply lines at faucet inlets that are located behind a basin or sink that protrudes downwardly into the undercounter volume, etc.

In anticipation of having to potentially turn many different components, plumbers may take to a site a large number of different tools to engage different components, as well as a range of sizes for each of the different tools.

Since it is generally impractical to place a large number of tools under a counter to perform different tasks, plumbers are often required to stage tools outside of the working volume and move back and forth, into and out of the undercounter volume, initially to assess what tools are needed, and thereafter to obtain and move the selected tool to the undercounter location where it will be used.

Recently, reconfigurable tools for plumbing applications have been designed to engage and turn components that differ significantly in terms of shape and dimension. Plumbers are not only required to turn components such as exposed valve handles, etc., but are also required to turn components while connected to conduits, such as water supply lines or water drains. There currently exists a turning tool category that is slotted to accommodate conduits while having interchangeable different component-engaging parts that can be translated into a connected relationship with a particular component to be turned.

Developers of reconfigurable plumbing tools also must take into account that undercounter site work is generally performed within a confined volume where lighting may be limited. The inability to reconfigure a tool readily and predictably within a relatively small undercounter volume may necessitate repeated movements into and out of the undercounter volume; which is inconvenient and time consuming.

The industry has been challenged to continue to improve these reconfigurable tools, particularly in the plumbing field, with focus on many of the competing objectives of: a) controlling cost; b) improving versatility; c) simplifying design; d) facilitating onsite reconfiguration, etc.

### SUMMARY OF THE INVENTION

In one form, the invention is directed to a reconfigurable tool for turning components with different configurations. The reconfigurable tool has: a base with a body having a turning axis and axially spaced first and second ends, with the body having a wall extending around the turning axis; and a first tool part having spaced ends and a first engaging part at one of the spaced ends of the first tool part that is configured to be operatively positioned with respect to a component with a first configuration. The base body and first tool part are configured so that the base body and first tool part can be: a) placed in a first starting relationship with the first tool part in radially spaced and axially overlapping relationship with the base body; and b) moved towards each other transversely to the turning axis from the first starting relationship into a first connected relationship. With the base body and first tool part in the first connected relationship and the first engaging part on the first tool part operatively positioned with respect to a component with the first configuration, movement of the base body around the turning axis causes the first tool part to turn the component with the first configuration.

In one form, the base and first tool part are configured so that as an incident of changing the base body and first tool part from the first starting relationship into the first connected relationship, the base body and first tool part are releasably keyed against relative axial movement and have one combined axial length.

In one form, the base body has first and second surfaces that are respectively in confronting relationship with first and second surfaces on the first tool part with the base body and first tool part in the first connected relationship. The confronting first and second surfaces on the base body and first tool part cooperate to limit relative movement between the base body and first tool part around the turning axis.

In one form, there is a first rib extending around the turning axis on one of the base body and first tool part and a first groove extending around the turning axis on the other of the base body and first tool part. The first rib and first groove are configured to cooperate so as to: a) guide relative movement between the base body and first tool part as the base body and first tool part are changed between the first starting relationship and first connected relationship; and b) key the base body and first tool part in the first connected relationship against relative axial movement.

In one form, one of the base body and first tool part has a first discrete projecting part and the other of the base body and first tool part has a first receptacle for the first discrete projecting part. The first discrete projecting part is advanced into the first receptacle as an incident of the base body and first tool part being changed from the first starting relationship into the first connected relationship. The first discrete projecting part and first receptacle cooperate, with the base body and first tool part in the first connected relationship, to limit relative movement between the base body and the first tool part at least one of: a) around the turning axis; and b) along the turning axis.

In one form, the first receptacle is defined on the base body wall and extends fully through the base body wall. The first tool part is advanced in one radial direction relative to the base body as the base body and first tool part are changed from the first starting relationship into the first connected relationship. With the base body and first tool part in the first connected relationship, a part of the first discrete projection is exposed at an outside surface of the base body wall, thereby allowing a user to exert a force on the part of the first discrete projection and thereby urge the first tool part relative to the base body in a direction oppositely to the one radial direction.

In one form, the base body wall extends around an open volume. A slot is formed in the base body wall between the first and second ends of the base body and is contiguous with the open volume. The first tool part has a wall extending around an open volume. A slot is formed on the wall of the first tool part and is contiguous with the open volume of the first tool part. With the base body and first tool part in the first connected relationship, the slots on the base body and first tool part align so that an elongate conduit, with which a component with the first configuration is associated, can be directed into the open volumes on the base body and first tool part while allowing the first engaging part to be operatively positioned with respect to the component with the first configuration.

In one form, the base body and first tool part are configured so that as an incident of the base body and first tool part being changed from the first starting relationship into the first connected relationship at least one of: a) a portion of the first tool part is frictionally captured between spaced first and second regions on the base body; and b) a part of at least one of the base body and first tool part is resiliently deformed to allow a holding surface on the first tool part to move past a holding surface on the base body and into confronting relationship once the base body and first tool part realize the first connected relationship so as to thereby releasably maintain the base body and first tool part in the first connected relationship.

In one form, the base body and first tool part are configured so that the base body and first tool part are guided in a predetermined manner from the first starting relationship consistently into the first connected relationship.

In one form, the base body and first tool part are changed from the first starting relationship into the first connected relationship and releasably maintained in the first connected relationship as an incident of press fitting a part of the first tool part into a volume bounded by the base body wall.

In one form, the base body and first tool part are configured so that the base body and first tool part can be: a) placed in a second starting relationship with the first tool part in radially spaced and axially overlapping relationship with the base body; and b) moved towards each other transversely to the turning axis into a second connected relationship. With the base body and first tool part in the second connected relationship and the first engaging part on the first tool part operatively positioned with respect to a component with the first configuration, movement of the base body around the turning axis causes the first tool part to turn the component with the first configuration. The base body and first tool part are configured so that the base body and first tool part are guided in a predetermined manner from the second starting relationship consistently into the second connected relationship. The base body and first tool part have different combined axial lengths in the first and second connected relationships.

In one form, a second engaging part is at the other of the spaced ends of the first tool part and is configured to be operatively positioned with respect to a component having a second configuration. The base body and first tool part configured so that the base body and first tool part can be: a) placed in another starting relationship with the first tool part in radially spaced and axially overlapping relationship with the base body and with the first tool part axially inverted from an orientation the first tool part has with the base body and first tool part in the first starting relationship; and b) moved towards each other transversely to the turning axis from the another starting relationship into another connected relationship. With the base body and first tool part in the another connected relationship and the second engaging part on the first tool part operatively positioned with respect to a component with the second configuration, movement of the base body around the turning axis causes the first tool part to turn the component with the second configuration.

In one form, the base body has an engaging part fixedly formed thereon and is configured to be operatively positioned with respect to a component with a second configuration to cause the component with the second configuration to turn as the base body is moved around the turning axis.

In one form, at one of the spaced ends of the first tool part an additional engaging part is provided to be operatively positioned with respect to a component with a third configuration.

In one form, the first tool part has an exposed surface on which indicia is placed to identify an aspect of the first engaging part.

In one form, the base body wall has an outer surface that can be grasped in a user's hand to facilitate manual movement of the base body around the turning axis.

In one form, the invention further includes a second tool part having spaced ends. The second tool part and base body are configured so that with the base body and second tool part placed in a first starting relationship, wherein the second tool part is spaced axially from the base body, the base body and second tool part can be moved axially towards and against each other into a first connected relationship wherein the base body and second tool part each follows movement of the other around the turning axis. With the second tool part and base body in their first connected relationship, the second tool part is at one of the first and second ends of the base body and defines at least one of: a) a connector for a tool usable to apply a force to the second tool part tending to move the second tool part around the turning axis; and b) an engaging part to be operatively positioned with respect to a certain component, whereupon movement of the second tool part around the turning axis causes the certain component to turn. With the base body and first tool part in their first connected relationship, the first tool part is at the other of the first and second ends of the base body.

In one form, the base body and second tool part are configured so that the base body and second tool part can be placed in a second starting relationship, wherein the second tool part is inverted from an orientation the second tool part has with the base body and second tool part in their first starting relationship and the second tool part is spaced axially from the base body. The base body and second tool part can be moved axially from their second starting relationship towards and against each other into a second, connected relationship wherein the base part and second tool part each follows movement of the other around the turning axis. With the base body and second tool part in their second connected relationship, the second tool part is at the one of the first and second ends of the base body and defines at least one of: a) a connector for a tool usable to apply a force to the second tool part tending to move the second tool part around the turning axis; and b) an engaging part to be operatively positioned with respect to a certain component, whereupon movement of the second tool part around the turning axis causes the certain component to turn.

In one form, with the base body and second tool part in their first connected relationship, a circumferential outer surface on the second tool part resides within and is in axially overlapping relationship with an inner circumferential surface on the base body. There is a plurality of tabs and tab receptacles that cooperate in circumferentially spaced pairs on the circumferential inner and outer surfaces to cause the base body and second tool part each to follow movement of the other around the turning axis.

In one form, the tabs and tab receptacles are configured so that the tabs and the receptacles cooperate to selectively key the base body and second tool part in different angular relationships. There is an additional engaging part at the one of the first and second ends of the base body configured to be operatively positioned with respect to an additional component with the second tool part separated from the base body so that movement of the base body around the turning axis causes the base body to turn the additional component. The additional engaging part is defined at least partially by the tab receptacles.

### BRIEF DESCRIPTION OF THE DRAWINGS

FIG. 1 is a schematic representation of a reconfigurable tool for turning components, according to the present invention;

FIG. 2 is a schematic representation of a base and first tool part on the reconfigurable tool in FIG. 1, and showing additional details thereof;

FIG. 3 is a schematic representation of a second tool part that may make up part of the reconfigurable tool, as shown in FIG. 1;

FIG. 4 is a schematic representation of the base as shown on the reconfigurable tool in FIG. 1, and showing additional details thereof;

FIG. 5 is a perspective view of one exemplary form of the base, as shown schematically on the reconfigurable tool in FIG. 1;

FIG. 6 is a view of the base in FIG. 5 from a different perspective;

FIG. 7 is a view of the base in FIGS. 5 and 6 from a further different perspective;

FIG. 8 is a view of the base in FIGS. 5-7 from a still further different perspective;

FIG. 9 is a partially schematic, cross-sectional view of the base taken along line 9-9 of FIG. 8;

FIG. 10 is a perspective view of one exemplary form of the first tool part, as shown schematically in FIG. 1;

FIG. 11 is a view of the first tool part in FIG. 10 from a different perspective;

FIG. 12 is an end elevation view of the first tool part as shown in FIGS. 10 and 11;

FIG. 13 is an end view of the base in FIGS. 5-9 and the first tool part in FIGS. 10-12, with a body of the base and first tool part in a separated, starting relationship preparatory to being connected;

FIG. 14 is a reduced, perspective view of a portion of the base body and the first tool part as in FIG. 13, preparatory to being placed in a connected relationship;

FIG. 15 is a view of the components, shown in FIG. 14 and from a different perspective;

FIG. 16 is a view of the base body and first tool part moved from a first starting relationship, as shown in FIGS. 14 and 15, into a first connected relationship;

FIG. 17 is a view of the components in the FIG. 16 state and from a different perspective;

FIG. 18 is a view of the components in the state in FIGS. 16 and 17 and from a different perspective;

FIG. 19 is a view as in FIG. 18 wherein the base body and first tool part have a different connected relationship with the first tool part axially inverted from the FIG. 18 orientation;

FIG. 20 is a perspective view of the first tool part and showing different engaging parts at opposite ends thereof enlarged;

FIG. 21 is a view as in FIG. 16 wherein the base and first tool part are placed in a different connected relationship;

FIG. 22 is a view of the components in FIG. 21 and from a different perspective;

FIG. 23 is a view as in FIG. 22 wherein the base and first tool part are in another connected relationship with the first tool part inverted from the FIG. 22 orientation;

FIG. 24 is a fragmentary, cross-sectional view of the operatively connected base body and first tool part, taken along lines 24-24 of FIG. 23;

FIG. 25 is a perspective view of the base and showing different engaging parts at the ends thereof enlarged;

FIG. 26 is a fragmentary perspective view showing an end of the base with a second tool part, as shown schematically in FIG. 3, in a first connected relationship;

FIG. 27 is a perspective view of the second tool part as shown in FIG. 26;

FIG. 28 is a view of the second tool part in FIG. 27 from a different perspective;

FIG. 29 is a view of the base body and second tool part of FIG. 26 in a first starting relationship from which the base body and second tool part are moved axially towards and against each other to be placed in the first connected relationship of FIG. 26;

FIG. 30 is a perspective view of the tool with the base body and second tool part moved from the starting relationship of FIG. 29 into a connected relationship and with the base body and first tool part in the connected relationship shown in FIG. 18;

FIG. 31 is a view of the components as in FIG. 30 from a different perspective;

FIG. 32 is a view of the components as in FIG. 30 wherein the second tool part is inverted from the FIG. 30 orientation and thereby in a different connected relationship with the base body and with the base body and first tool part in the connected relationship shown in FIG. 19;

FIG. 33 is an enlarged, cross-sectional view of the operatively connected base and first and second tool parts, taken along lines 33-33 of FIG. 31 and with cooperating parts of the base and first tool part further enlarged;

FIG. 34 is a perspective view of the second tool part and showing engaging parts at the ends thereof enlarged;

FIG. 35 is a perspective view of the base body with the first tool part in the starting relationship shown in FIG. 15 and the base body and second tool part in the starting relationship of FIG. 29;

FIG. 36 is an enlarged view of the components in the FIG. 31 relationship and from a different perspective;

FIG. 37 is a view of the components as in FIG. 36 and from another perspective;

FIG. 38 is a fragmentary view of an end of the base body with a discrete projecting part on the second tool part extended into an opening/slot on the base body with the base body and second tool part in a connected relationship;

FIG. 39 is a fragmentary, cross-sectional view of parts of the connected base body and second tool part taken along line 39-39 of FIG. 36; and

FIG. 40 is a schematic representation of cooperating connectors on the base body and first tool part.

### DETAILED DESCRIPTION OF THE PREFERRED EMBODIMENT

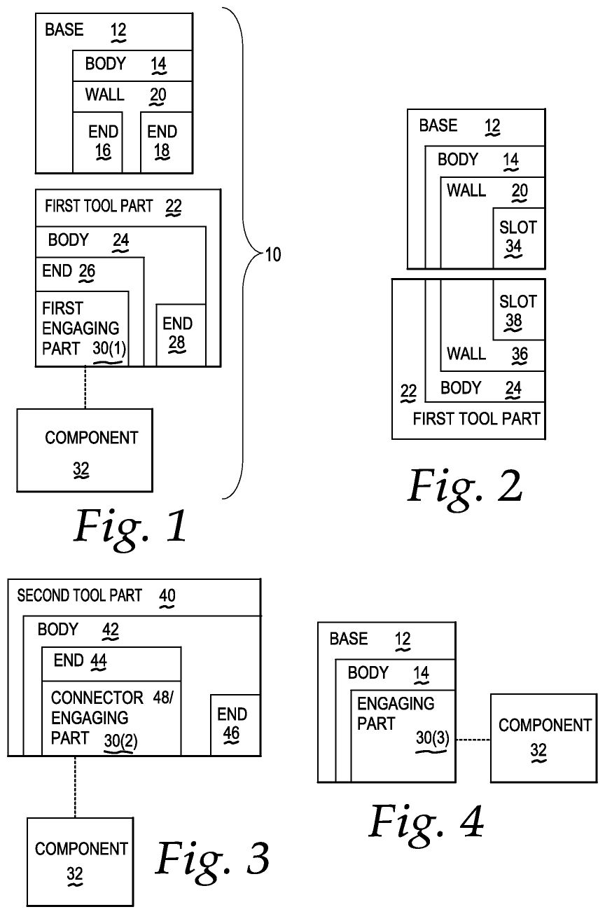

A basic form of reconfigurable tool for turning components with different configurations, according to the present invention, is shown schematically at 10 in FIG. 1. The reconfigurable tool 10 consists of a base 12 with a body 14 having a turning axis and axially spaced ends 16, 18. The body 14 has a wall 20 that extends around: a) the turning axis for the base body 14; and b) an open volume through which the turning axis extends.

A first tool part 22 has a body 24 with spaced ends 26, 28, with a first engaging part 30(1), at one of the ends 26, that is configured to be operatively positioned with respect to a component 32 with a first configuration.

The base body 14 and first tool part 22 are configured so that the base body 14 and first tool part 22 can be: a) placed in a first starting relationship with the first tool part 22 in radially spaced and axially overlapping relationship with the base body 14; and b) moved towards each other transversely to the turning axis from the first starting relationship into a first connected relationship.

With the base body 14 and first tool part 22 in the first connected relationship, and the first engaging part 30(1) operatively positioned with respect to the component 32 with the first configuration, movement of the base body 14 around the turning axis causes the first tool part 22 to turn the component 32 with the first configuration.

The schematic depiction of the elements in FIG. 1, as the elements in all of the schematic depictions herein, is intended to encompass virtually an unlimited number of variations of the elements and their interactions, with the specific forms disclosed herein being exemplary in nature only.

Within the schematic depiction in FIG. 1, it is contemplated that different elements on the base 12 and first tool part 22 may cooperate to control relative movement between the base 12 and first tool part 22, both around and along the turning axis, during the connection process and with the base 12 and first tool part 22 in connected relationship. These cooperating elements may permit different connected relationships, as described hereinbelow, to be established and releasably maintained.

In one preferred form, the tool 10 can be adapted for turning components that are integrated into a conduit, as with conventional plumbing, such as a hex nut, a wingnut, or other form of threaded fastener. As shown in FIG. 2, the wall 20 on the body 14 of the base 12 extends around the aforementioned open volume. A slot 34 is formed on the wall 20 and is contiguous with this volume.

The body 24 of the first tool part 22 has a wall 36 that extends around an open volume with a slot 38 formed on the wall 36 so as to be contiguous with the open volume on the first tool part body 24.

With the base body 14 and first tool part 22 in the first connected relationship, the slots 34, 38 align so that an elongate conduit, with which a component 32 with the first configuration is associated, can be directed into the combined open volumes while allowing the first engaging part 30(1) to be operatively positioned with respect to the component 32 with the first configuration.

As shown in FIG. 3, a second tool part 40 has a body 42 with spaced ends 44, 46. The second tool part 40 and base body 14 are configured so that with the base body 14 and second tool part 40 placed in a first starting relationship, wherein the second tool part 40 is spaced axially from the base body 14, the second tool part 40 and base body 14 can be moved axially towards and against each other into a first connected relationship, wherein the base body 14 and second tool part 40 each follows movement of the other around the turning axis. In this first connected relationship, the second tool part 40 is at one of the ends 16, 18 of the body 14 of the base 12 and defines at least one of: a) a connector 48 for a tool usable to apply a force to the second tool part 40 tending to move the second tool part 40 around the turning axis; and b) an engaging part 30(2) to be operatively positioned with respect to a certain component 32 whereupon moving of the second tool part 40 around the turning axis causes the certain component 32 to turn.

As shown in FIG. 4, the body 14 on the base 12 may define at least one engaging part 30(3) to be operatively positioned with respect to a compatible component 32, whereupon movement of the base body 14 around the turning axis causes the engaged, compatible component 32 to turn.

In one preferred form, the first tool part 22 and second tool part 40 are usable at opposite ends of the base body 14. For purposes of simplicity, in the description and claims herein, the first and second tool part bodies 24, 42, respectively, will be considered to be “at” the one of the ends 16, 18 at which the tool parts are usable.

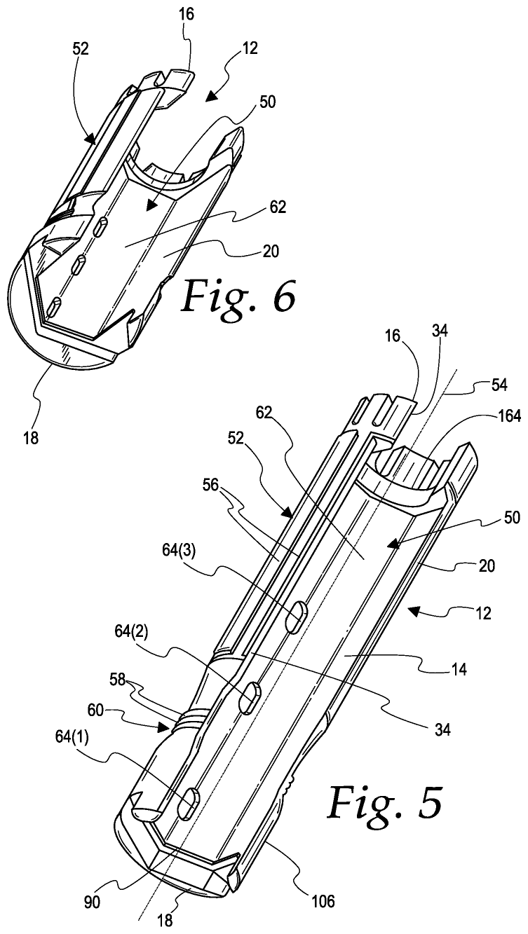

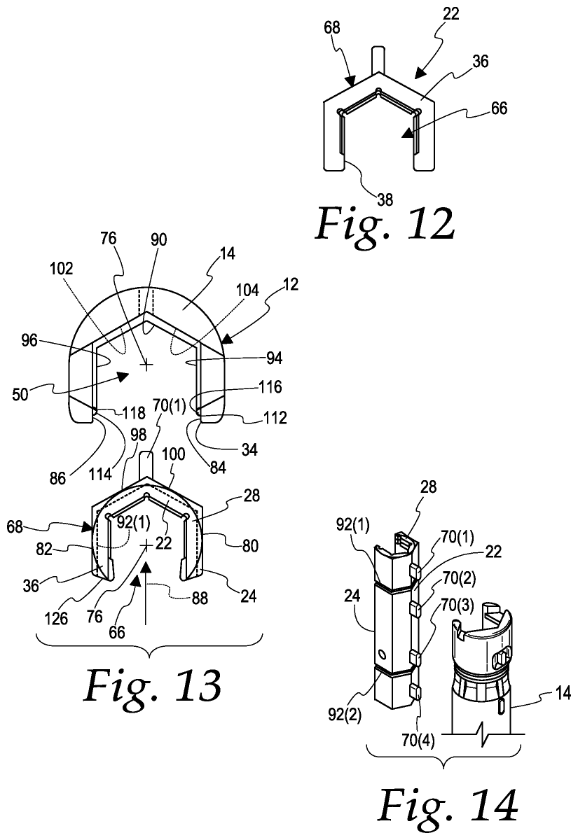

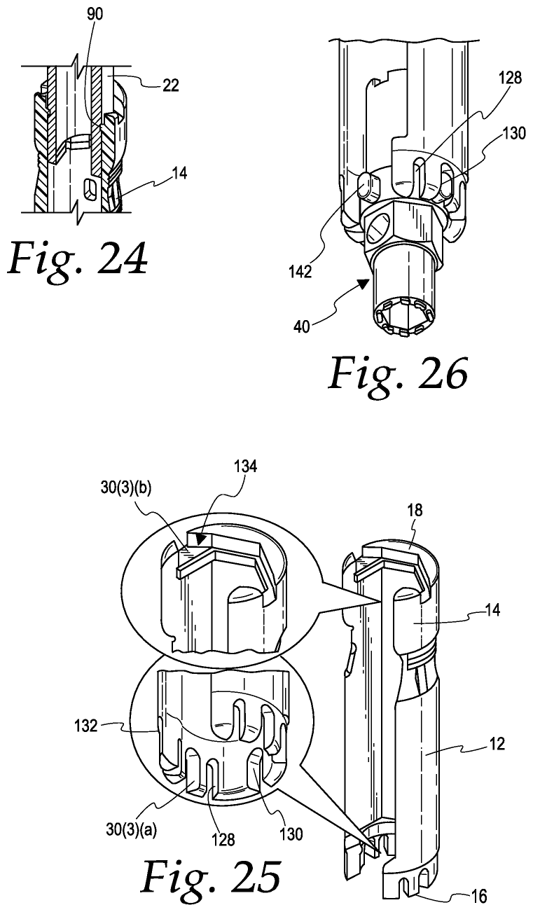

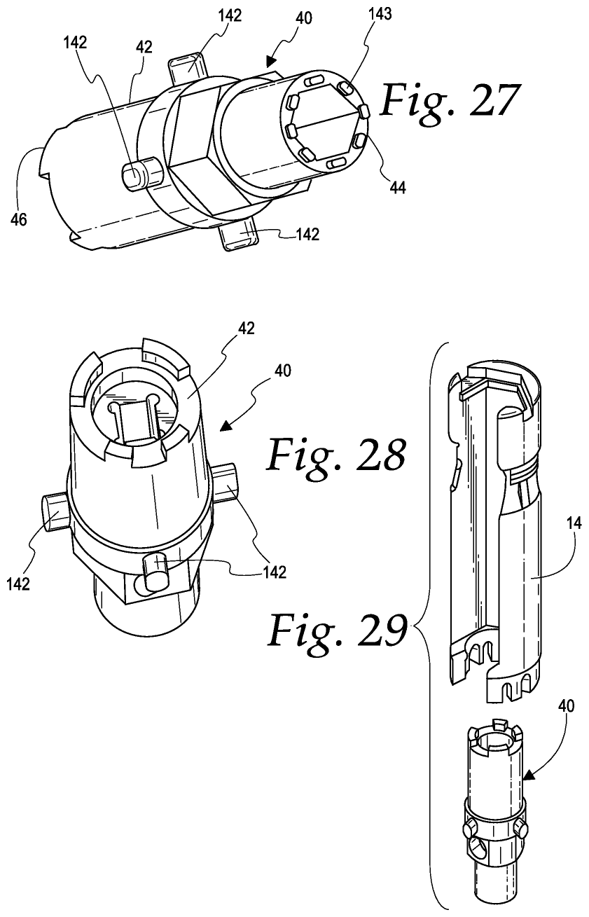

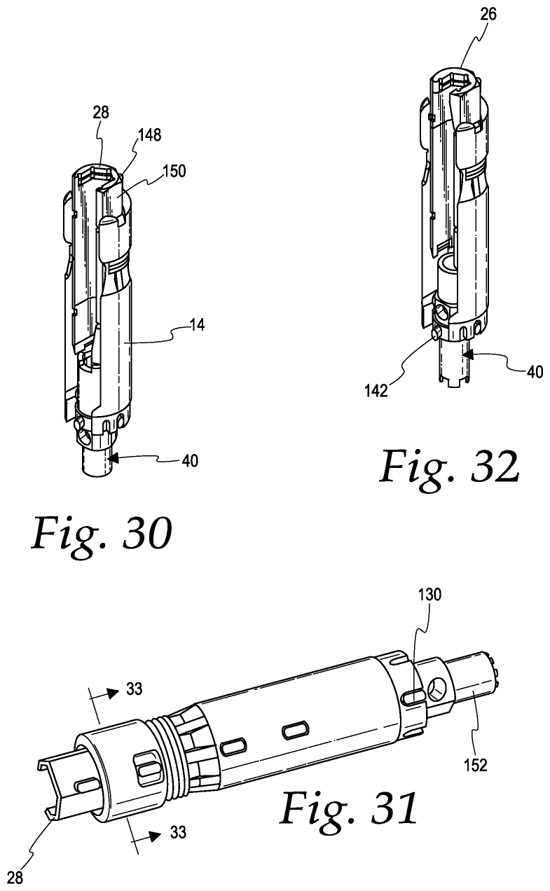

Specific forms of the reconfigurable tool 10 will now be described with respect to FIGS. 5-40. It should be mentioned that while the base body 14, first tool part 22, and second tool part 40 each is described as having multiple engaging parts 30, this is not a requirement and further the exemplary engaging parts 30 depicted should not be viewed as limiting. For example, the base body 14 may have no engaging parts. As another example, the first and second tool part bodies 24, 42 may have one or more engaging parts at only one end thereof.

Referring initially to FIGS. 5-9, details of the base 12 can be clearly seen.

The body 14 of the base 12 has a generally cylindrical overall shape, with the wall 20 extending around the aforementioned volume 50 and interrupted by the slot 34 that extends fully between the body ends 16, 18.

The wall 20 has a textured outer surface 52 to facilitate grasping within the hand of a user and positive movement thereof around the aforementioned turning axis 54.

Without limitation, the texturing consists of circumferentially spaced, axially extending ribs 56 that reduce the likelihood of slipping of the body 14 in a user's hand as he/she imparts a torque thereupon.

Axially spaced, circumferentially extending ribs 58 control axial slippage of the hand of a user gripping the outer surface 52.

The wall 20 is locally reduced in diameter at a region at 60 where the ribs 58 are located, which creates an additional contour that avoids axial slippage of the user's hand grasping along the outer surface 52. The locally reduced region 60 creates spaced transition shoulders 61a, 61b at which a user can exert axially opposite forces, as to bear an engaging part against a component to be turned.

The inner circumferential surface 62 of the wall 20, as viewed along the axis 54, has a substantially hexagonal shape that is interrupted by the slot 34.

Openings/receptacles 64 are formed in/through the wall 20. As will be explained below, while the depicted embodiments are exemplary preferred forms, it is contemplated that any of the number, configuration, spacing, relative positioning, etc. of the openings/receptacles 64 might be changed from the depicted forms. In the depicted form, the openings/receptacles 64 each is axially elongate with a generally oval shape. Three openings/receptacles 64(1), 64(2), 64(3) are formed through the wall 20, generally diametrically opposite to the location of the slot 34.

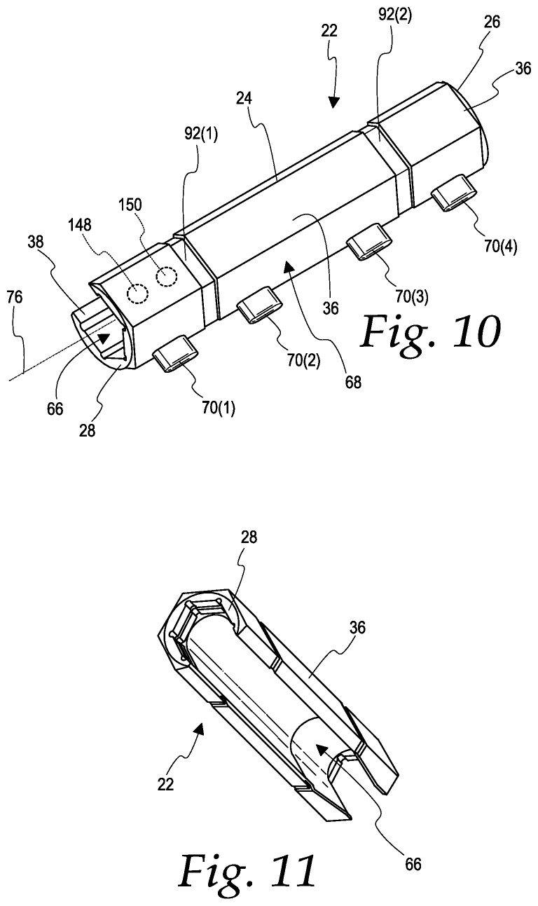

An exemplary form of the first tool part 22 is shown clearly in FIGS. 10-12. The wall 36 on the body 24 of the first tool part 22 extends around the aforementioned volume 66 defined between the body ends 26, 28.

The outer surface 68 of the wall 36 is configured and dimensioned to be passed through the slot 34 on the base body 14 and at least nominally matches a hexagonal shape of the inner circumferential surface 62 on the base body 14. The hexagonal shape of the outer surface 68 is interrupted by the slot 38, that extends fully between the body ends 26, 28.

A plurality of, and in this case four, discrete, axially spaced, projecting parts 70(1), 70(2), 70(3), 70(4) extend away from the wall 36 at locations diametrically opposite to the location of the slot 38.

The projecting parts 70 are configured and axially spaced to cooperate with the openings/receptacles 64 in different pairings to permit different connected relationships between the first tool part 22 and base body 14 to be established.

While the depicted embodiments are exemplary, preferred forms of the invention, it is contemplated that, as noted previously, the precise number and nature of engaging parts 30 on each of the base 12, first tool part 22, and second tool part 40 may be changed from the depicted forms. Further, it is contemplated that the exact number of different connected relationships between the base body 14 and first tool part 22 may be changed from the depicted forms—the number of connected relationships can be less, or more, than the number of connected relationships made possible with the specific exemplary forms of the invention described herein.

For all of the connected relationships disclosed herein, as shown schematically in FIG. 40, there are different forms of connectors 72 on the base body 14 that cooperate with connectors 74 on the first tool part 22 to: a) guide the base body 14 and second tool part 40 consistently into different connected relationships; b) key the base body 14 and first tool part 22 against relative axial movement once in different connected relationships; and c) cause the base body 14 and first tool part 22 to move together around the turning axis 54. Various exemplary forms of the connectors 72, 74 will be described hereinbelow, with it understood that not all of the described cooperating connectors 72, 74 need to be provided, with each of the connectors 72, 74 potentially taking a different configuration than the exemplary forms herein.

In FIGS. 16-18, the base body 14 and first tool part 22 are shown in a first connected relationship wherein the second tool part 40 is nested in the volume 50 on the base body 14 with a lengthwise axis 76 on the body 24 aligned with and substantially coincident with the turning axis 54 on the base body 14. In this first connected relationship, the base body 14 and first tool part 22 have a combined length L (FIG. 16) between the end 16 of the base body 14 and the end 28 of the body 24 on the second tool part 22.

To establish this first connected relationship, the base body 14 and first tool part 22 are placed in a first starting relationship, as shown in FIGS. 13-15, wherein the first tool part 22 is in radially spaced and axially overlapping relationship with the base body 14.

The angular orientations of the base body 14 and first tool part 22 in their first starting relationship, as seen clearly additionally in FIG. 13, is such that oppositely facing, parallel surface portions 80, 82, on the outer surface 68 of the first tool part 22 align in parallel relationship with facing and parallel surface portions 84, 86 on the inner circumferential surface 62 on the base body 14.

The relative spacing between the surface portions 80, 82 and 84, 86 is such that when the first tool part 22 is advanced in the direction of the arrow 88 in FIG. 13 into the volume 50 on the base body 14, the first tool part 22 is consistently guided through the cooperating surface portions 80, 82 and 84, 86 in a straight line until the first connected relationship between the base body 14 and first tool part 22 is realized.

The relative spacing between the surface portions 84, 86 and 80, 82 may be selected so that limited frictional forces are generated therebetween tending to releasably maintain the connected relationship of the base body 14 and first tool part 22, once realized.

The surface portions 84, 86 represent one form of the connectors 72 as shown schematically in FIG. 40, that cooperate with the surface portions 80, 82, representing one form of the connectors 74, as also shown schematically in FIG. 40.

A rib 90 extends around the turning axis 54 of the base body 14 and projects radially inwardly from the inside surface 62 thereof. As depicted, the rib 90 extends fully around the circumferential extent of the surface 62. This degree of circumferential extension is not required.

The rib 90 is configured to cooperate with a groove 92(1) in FIG. 13, that is one of two like, axially spaced grooves 92(1), 92(2), each extending fully around the outer surface 68 of the first tool part 22. It is also not required that the grooves 92 extend fully around the surface 68, as shown.

With the base body 14 and first tool part 22 in the first starting relationship, advancement of the first tool part 22 in the direction of the arrow 88 in FIG. 13 causes spaced portions 94, 96 of the rib 90 to initially advance into the groove 92(1) where it is recessed below the surface portions 80, 82, respectively.

Once the first tool part 22 is fully seated and the first operative relationship between the base body 14 and first tool part 22 is realized, the rib 90 seats within the groove 92(1) over the full coextension of the rib 90 and groove 92(1). At the same time, surface portions 98, 100 on the outer surface 68 of the first tool part 22 respectively confront surface portions 102, 104 on the inner circumferential surface 62 on the base body 14. Some or all of the confronting surface portions on the base body 14 and first tool part 22 cooperate to cause the base body 14 and first tool part 22 to move together around the turning axis 54.

It is not necessary that all of the confronting surface portions on the base body 14 and first tool part 22 be directly against each other to accomplish this function. These cooperating surface portions represent another form of the connectors 72, 74, as shown schematically in FIG. 40.

Further, the rib 90 and groove 92(1), which respectively represent another form of the connectors 72, 74, cooperate to consistently guide movement of the base body 14 and first tool part 22 against each other as their relationship is changed between the first starting relationship and the first connected relationship. At the same time, the rib 90 and groove 92(1) key the base body 14 and first tool part 22 against relative axial movement with the base body 14 and first tool part 22 in the first connected relationship.

Of course, it should be understood that the base body 14 and first tool part 22 would cooperate in the same fashion if the rib was provided on the first tool part 22 and the groove was provided on the base body 14—an equivalently functioning reversal of elements.

With the base body 14 and first tool part 22 in the first starting relationship, the projecting parts 70(2), 70(3), 70(4) successively align with the openings/receptacles 64(1), 64(2), 64(3). As an incident of the base body 14 and first tool part 22 being changed from the first starting relationship into the first connected relationship, the projecting parts 70(2), 70(3), 70(4) are advanced adequately to each make a keyed connection within the respective openings/receptacles 64(1), 64(2), 64(3). The projecting part 70(1) does not extend into the base body 14. As seen in FIGS. 16 and 17, the projecting parts 70(3), 70(4) are preferably substantially flush with the outer surface 52 of the base body 14 so as not to define an irritant when gripping the base body 14.

An axial length 106 of the base body 14 is radially thickened at the body end 18, compared to the region where the projecting parts 70(3), 70(4) reside, to provide greater structural integrity whereat one or more engaging parts 30(3) are provided, to accommodate different components to be turned, as explained below. A discrete radial undercut 108 is provided within the axial length 106 around the opening/receptacle 64(1) to allow the free end 110 of the projecting part 70(2) to project from, or to be flushly situated at, the base of the undercut 108.

With this arrangement, with the base body 14 and first tool part 22 in the first connected relationship, the exposed free end 110 of the projecting part 70(2) can be pressed radially inwardly—radially oppositely to the direction indicated by the arrow 88 in FIG. 13—to urge the first tool part 22 out of the base body volume 50 to facilitate separation of the first tool part 22 from the base body 14.

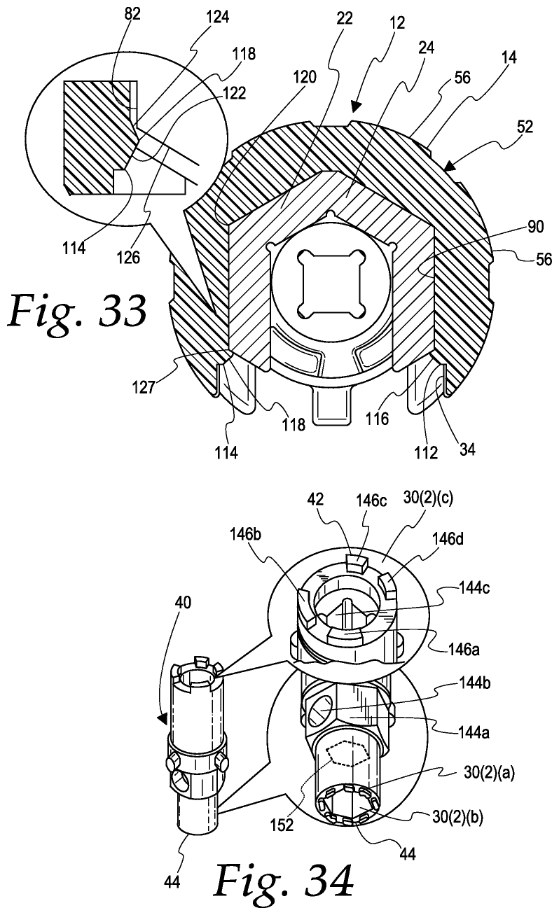

This release feature is particularly desirable when a snap-fit feature, as shown clearly in FIGS. 13 and 33, is incorporated. At the entry location to the volume 50, defined by the slot 34, spaced ends 112, 114 of the rib 90 have radially thickened parts 116, 118. As seen at the exemplary rib end 114, as the first tool part 22 is advanced into the volume 50, a corner 120 on the first tool part body 24, within the groove 92(1), contacts a cam surface 122 on the thickened part 118 and progressively squeezes the thickened portion 118 until the surface portion 82 is allowed to fully pass thereover, whereupon the thickened portion 118 springs back to place a surface/edge 124 thereon biasably against another surface portion 126 adjacent a trailing corner 127 within the groove 92(1). This spring back of the thickened portion 118 creates a releasable snap-fit connection with the first tool part body 24 becoming captured at multiple diametrically opposite regions/locations.

The other thickened portion 116 cooperates with the first tool part body 24 in like fashion to create a stronger connection.

The strategic location of the free end 110 of the projecting part 70(2) gives the user substantial leverage when releasing the snap connection between the base body 14 and first tool part 22. That is, the projection 70(2) is close enough, in an axial direction, to the rib-and-groove connection location that the radial releasing force can be applied without allowing the relationship between the base body 14 and first tool part 22 to significantly skew, as might cause binding of the rib within the groove.

The particular configuration of the projecting parts 70 and cooperating openings/receptacles 64 is not limited to the depicted form. The form depicted—matching oval shapes—allows the projecting parts 70 and openings/receptacles 64 to cooperate as another form of connector, as shown in FIG. 40, to positively key the base body 14 and first tool part 22 together against both relative axial and angular movement.

The thickened parts 116, 118 and cooperating portions of the surface portions within the groove 92(1) on the first tool part 22 represent yet another cooperating connector arrangement as depicted schematically in FIG. 40.

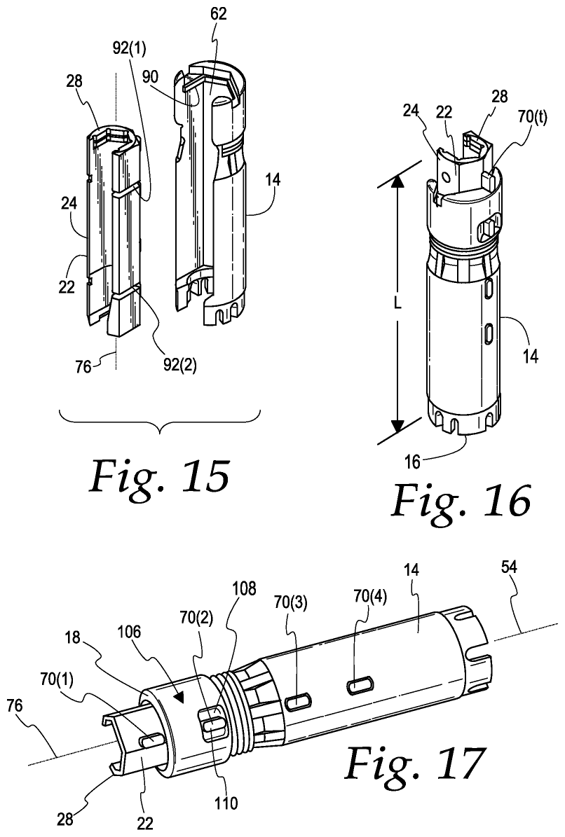

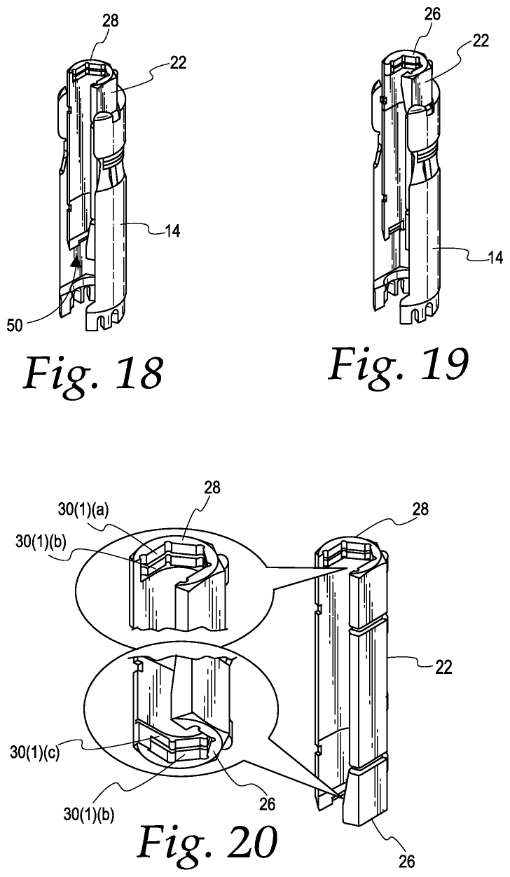

In the depicted embodiment, the arrangement of the projecting parts 70 and grooves 92 is such that the first tool part 22 can be axially inverted from the orientation shown in FIGS. 14 and 15, to assume a second starting relationship which is essentially the same as a first starting relationship, and thereafter be changed in the same fashion, as described above, into a second connected relationship corresponding basically to the first connecting relationship. The primary difference is that in the second connected relationship, as shown in FIG. 19, the end 26 of the first tool part body 22 is exposed, whereas in the first connected relationship the end 28 of the first tool part body 22 is exposed, as shown in FIG. 18, which corresponds to the FIG. 19 arrangement. In the second connected relationship, the groove 92(2) and projecting parts 70(1), 70(2), 70(3) act as the connectors 74.

As previously noted, the number and configuration of engaging parts 30 associated with each of the first tool part 22, the second tool part 40, and the base 20 may change considerably from the forms depicted. The forms described hereinbelow are exemplary in nature only.

For example, as shown in FIG. 20, the first tool part 22 has at the end 28 two different engaging parts 30(1)(a) and 30(1)(b), with two different engaging parts 30(1)(c) and 30(1(d) at the end 26. In this particular exemplary embodiment, the engaging part 30(1)(a) defines a 15/16 inch open hex socket with the engaging part 30(1)(b) defining a ⅞ inch open hex socket.

The engaging part 30(1)(c) defines a ⅝ inch open hex socket, with the engaging part 30(1)(d) defining a ¾ inch open hex socket.

It is known in the art how to incorporate sockets with different dimensions at a single end opening.

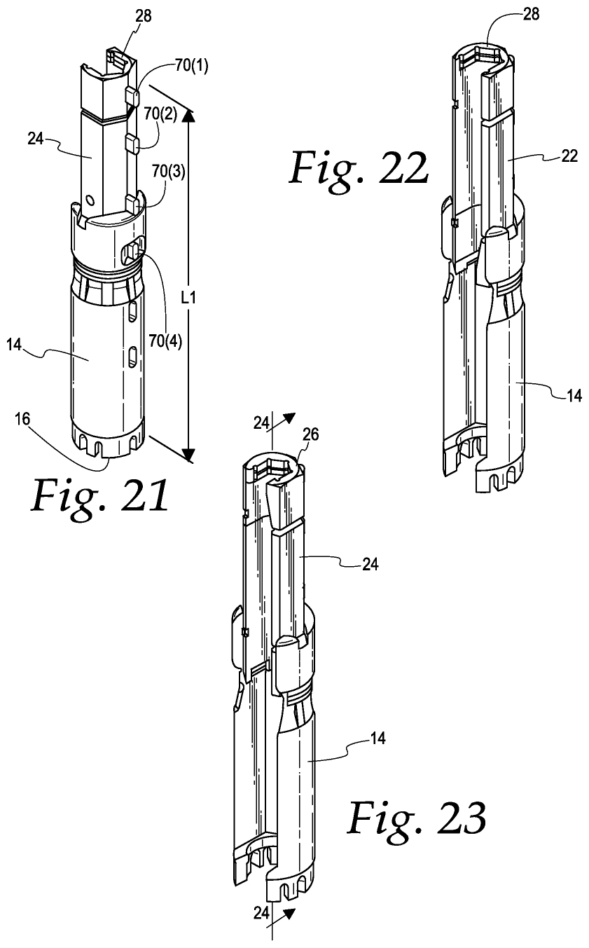

With the above-described components, another connected relationship between the base body 14 and first tool part 22 can be established as shown in FIG. 21. Rather than aligning the groove 92(1) with the rib 90, the groove 92(2) is aligned therewith in a corresponding starting relationship. Changing between the starting relationship and the connected relationship takes place in the same manner. As this occurs, the projecting part 70(4) is advanced into the opening/receptacle 64(1). The primary difference between the connected relationships in FIG. 16 and FIG. 21 is that the combined length L1 between the end 28 of the first tool part body 24 and the end 16 of the base body, as shown in FIG. 21, is greater than the corresponding length L, as shown in FIG. 16.

This same length (L1) and same basic cooperation between the base body 14 and first tool part 22 can be achieved by axially inverting the second tool part 22 from the FIG. 21 orientation and connecting the base body 14 and first tool part 22 in the same manner such that the groove 92(1) cooperates with the rib 90, the projecting part 70(1) extends into the opening/receptacle 64(1), and the end 26 of the first tool part body 24 is exposed for use. This connected relationship is shown in FIG. 23.

It should be understood that using the basic structure as described above, many different structural variations may be derived. As an example, and without limitation, one or more additional ribs may be provided, as on the base body. The tool part may have multiple grooves, in excess of two, that engage separately or at the same time with multiple ribs. The ribs may be placed in different relationships on each respective component to allow virtually an unlimited number of different connected relationships to be arrived at.

Similarly, the arrangement and number of cooperating projecting parts and openings/receptacles may vary considerably from the depicted form.

In the depicted embodiment, the base 12 has engaging parts 30(3)(a) and 30(3)(b), respectively at its ends 16, 18, as seen clearly in FIG. 25.

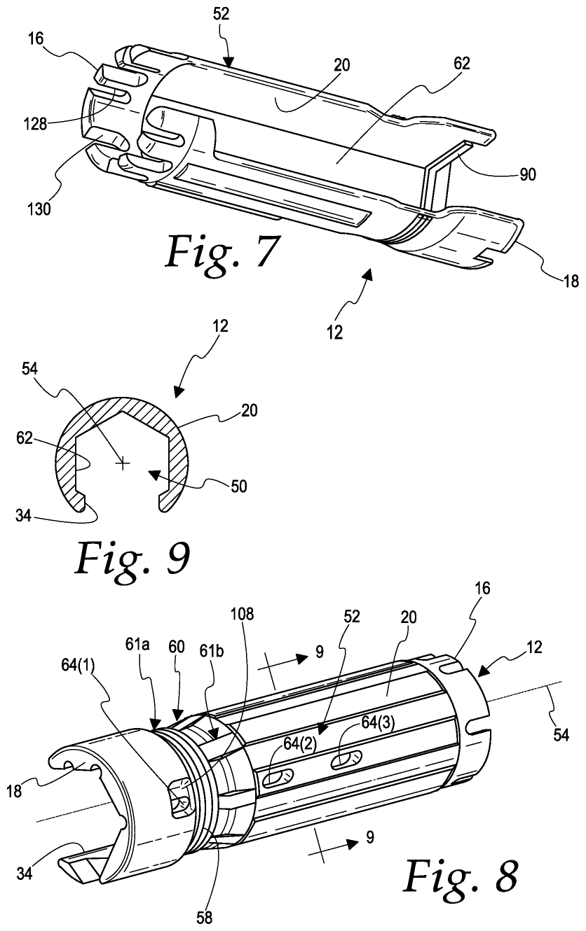

The engaging part 30(3)(a) is defined by a plurality of circumferentially spaced small and large slots/receptacles 128, 130 (see also FIG. 7), respectively, formed through a locally thickened portion of the wall 20 at 132 at the end 16. The slots/receptacles 128, 130 cooperatively define a configuration characterized as a tab mount wrench, with the different slots/receptacles 128, 130 strategically located to be operatively used to engage numbers 2, 3, 4, and 6 tab nuts.

The engaging part 30(3)(b) is configured as a contoured receptacle 134 that functions as a valve wrench.

One form of the second tool part 40 is shown clearly in FIGS. 26-29, and as designed, performs multiple functions: a) to engage components 32 and move with the base body 14 to effect turning thereof; and b) to act as a drive input for engaging parts on any of the base 12, first tool part 22, and second tool part 40.

The body 42 of the second tool part 40 is substantially cylindrical, with a stepped diameter between the ends 44, 46 thereof.

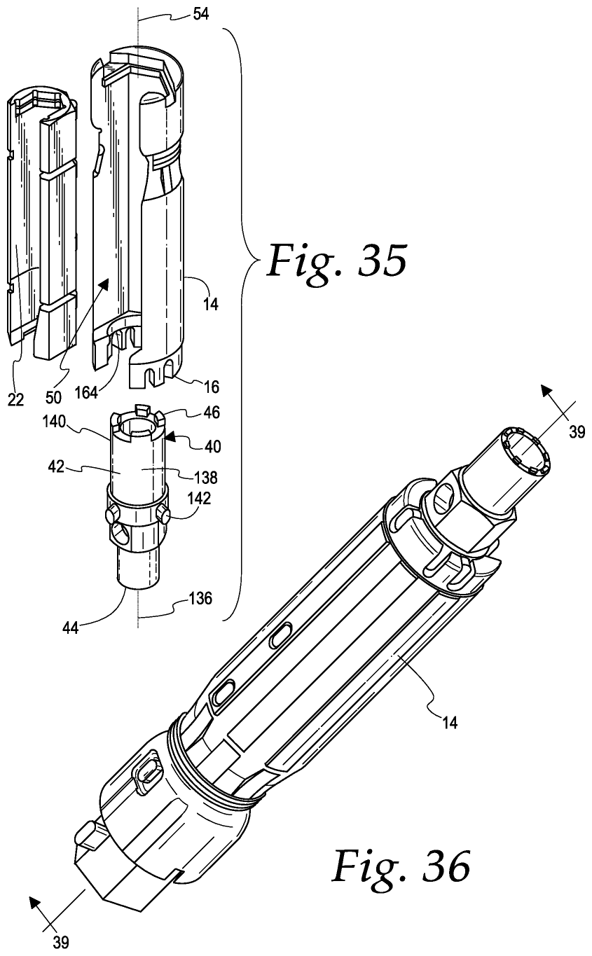

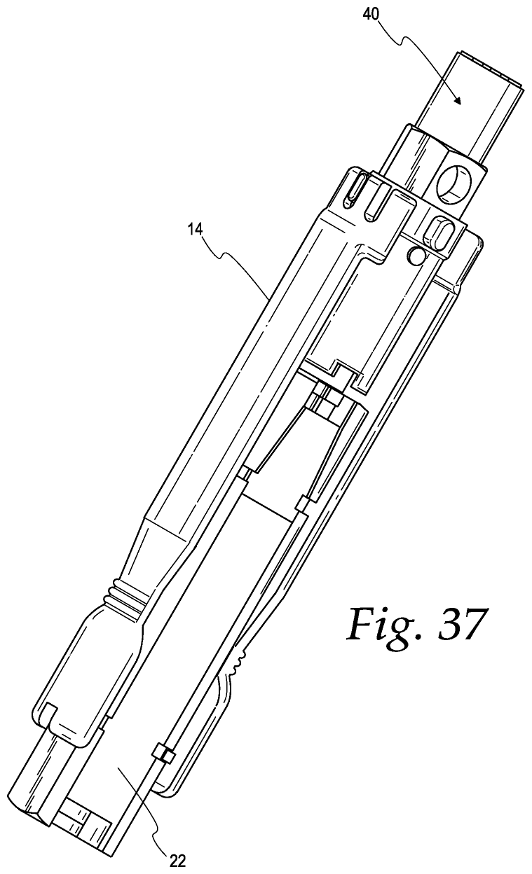

In FIGS. 29 and 35, the second tool part 40 is shown in a first starting relationship with the base body 14, wherein an axis 136 of the second tool part body 42 is substantially aligned with the turning axis 54 for the base body 14, with the second tool part body 42 spaced axially from the base body end 16. The base body 14 and second tool part 40 are changed from the first starting relationship into a first connected relationship, as shown for example in FIGS. 36 and 37, by moving the base body 14 and second tool part 40 axially towards and against each other, which causes a larger diameter portion 138 of the body 42 to move within the volume 50 of the base body 14 so that an outer surface 140 on the portion 138 resides within and is in axially overlapping relationship with the inner circumferential surface on the base body 14.

In the first connected relationship, a plurality of tabs 142, projecting radially outwardly and in circumferentially spaced relationship on the second tool part body 42, move one each into the larger slots/receptacles 130, thereby causing the base body 14 and second tool part 40 to be keyed together so that the base body 14 and second tool part 40 follow each other in movement around the turning axis 54.

In this embodiment, the slots/receptacles 130 extend through the inside peripheral surface of the base body 14 and fully through the wall 20 to create the component engagement capability, as described above.

In the depicted form, the slots/receptacles 130 are strategically, relatively angularly positioned so that the tabs 142 and slots/receptacles 130 can be engaged with at least one angular relationship, and potentially different angular relationships, between the base body 14 and the second tool part 40.

The second tool part 40 has two engaging parts 30(2)(a) and 30(2)(b) at its end 44 that are usable with the base body 14 and second tool part 40 in their first connected relationship.

More specifically, and without limitation, the engaging part 30(2)(a) has projections 143 that are strategically shaped and located to cooperatively perform as an aerator wrench. The engaging part 30(2)(b) defines a ⅝ inch socket wrench.

The second tool part 40 additionally provides separate connectors 144(a), 144(b), corresponding to the connector 48 schematically depicted in FIG. 3, for a tool usable to apply a force to the second tool part 40, urging the second tool part 40 around the turning axis, which drives the base body 14 that is in connected relationship with the first tool part 22.

In the depicted form, the connector 144a has a hexagonal shape that matches to a conventional open end wrench receptacle. As one example, the drive may be for a 1⅛ inch wrench.

The connector 144b is in the form of a radial through opening that allows a shaft, such as on a screwdriver, to be directed therethrough and leveraged to turn the second tool part 40 around its axis 136.

As depicted, the connector 144b is formed through the hexagonally-shaped connector 144a. This compacts the overall design in an axial direction and potentially creates a more rigid structure for a turning tool, by reason of the increased diameter.

The second tool part 40 can be axially inverted from the FIG. 35 orientation and placed into a corresponding second connected relationship, as shown in FIG. 32, by reason of repeating the aforementioned steps. That is, the tabs 142, which are symmetrical in shape at axial opposite ends, are advanced into the slots/receptacles 130 to effect a keyed connection. This inverted relationship causes the end 46 of the second tool part body 42 to be exposed for use.

In this embodiment, there are strategically configured and spaced projections 146a, 146b, 146c, 146d that cooperatively define a configuration to perform as a strainer wrench/engaging part 30(2)(c). The depicted arrangement is for a No. 3 and No. 4 strainer wrench.

Additionally, the second tool part 40 defines a connector 144c, corresponding to the connector 46 in FIG. 1, in the form of a receptacle for a square drive, which may be, for example, a ⅜ inch drive.

The above described components allow for several different configurations for the tool 10 to be selected which allow it to be used in different manners. As just examples and without limitation, the base 12 can be used by itself to engage and turn components at its ends 16, 18.

The base 12 can be used with either or both of the first tool part 22 and second tool part 40 operatively connected.

In a preferred form, the base body 14 is made from a non-metal material, such as glass-filled nylon. This particular material is not intended to be limiting, nor is it required that the base body 14 be made from a non-metal material.

In one preferred form, the first tool part 22 and second tool part 40 are both made from a die cast material, such as aluminum that may be zinc coated.

For the convenience of a user, indicia are provided at, or adjacent, some or all of the locations at which there are engaging parts 30. As just an example, in FIG. 10, separate indicia, depicted generically at 148, 150, may numerically identify a dimensional characteristic, such as the size of the adjacent hex wrench structure.

The indicia may identify, as by a pictorial representation thereof, a component that the particular engaging part is designed to interact with and turn—such as a valve handle, a strainer, etc. In FIG. 34, the indicia 152 is a depiction of a strainer shape.

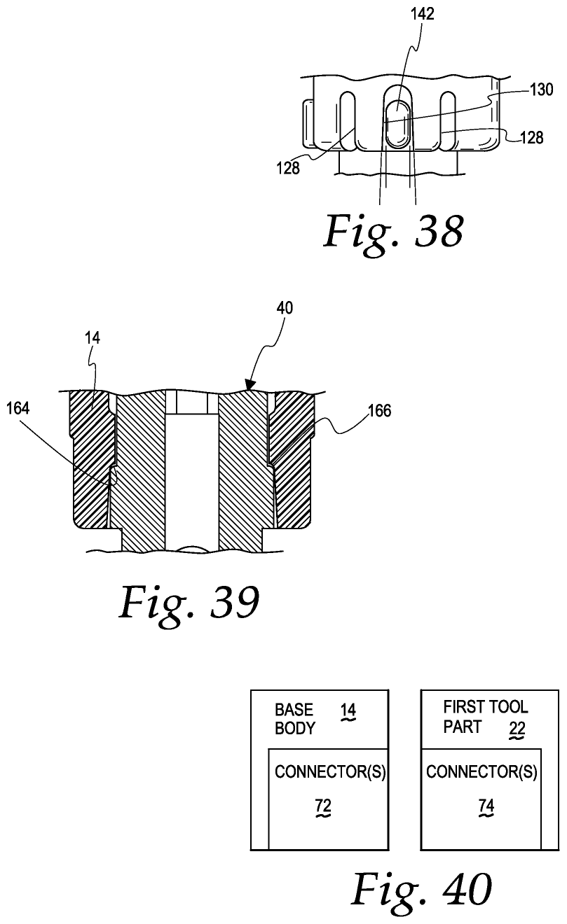

As shown in FIGS. 38 and 39, a feature may be incorporated that facilitates controlled positive engagement between the second tool part 40 and the base body 14. The tabs 142 and cooperating slots/receptacles 130 may have cooperating shapes that cause a progressively increasing frictional force to be generated between the tabs 142 and the surfaces surrounding the slots/receptacles 130 as the tabs 142 advance into the slots/receptacles 130. This may be accomplished by having at least one of the slots 130 with a width that changes in an axial direction, as shown in FIG. 38, whereby an increasing wedging force is generated as the tab 142 moves progressively into a respective slot/receptacle 130.

An annular shoulder 164 (see also FIG. 5) on the base body 14 abuts an annular shoulder 166 on the second tool part 40 to consistently establish one predetermined connected relationship. In this predetermined relationship, a desired frictional holding force between the base body 14 and second tool part 40 results that securely maintains a connected relationship while allowing the base body 14 and second tool part 40 to be separated therefrom with a reasonable/comfortable force application by a user. This avoids a situation wherein the base 14 and second tool part 40 are moved under a large force against each other and become tightly wedged together and difficult to separate.

The foregoing disclosure of specific embodiments is intended to be illustrative of the broad concepts comprehended by the invention.

1. A reconfigurable tool for turning components with different configurations, the reconfigurable tool comprising:
a base with a body having a turning axis and axially spaced first and second ends,
the body having a wall extending around the turning axis; and
a first tool part having spaced ends and a first engaging part at one of the spaced ends of the first tool part that is configured to be operatively positioned with respect to a component with a first configuration,
the base body and first tool part configured so that the base body and first tool part can be: a) placed in a first starting relationship with the first tool part in radially spaced and axially overlapping relationship with the base body; and b) moved towards each other transversely to the turning axis from the first starting relationship into a first connected relationship,
whereupon with the base body and first tool part in the first connected relationship and the first engaging part on the first tool part operatively positioned with respect to a component with the first configuration, movement of the base body around the turning axis causes the first tool part to turn the component with the first configuration.

2. The reconfigurable tool according to claim 1 wherein the base and first tool part are configured so that as an incident of changing the base body and first tool part from the first starting relationship into the first connected relationship, the base body and first tool part are releasably keyed against relative axial movement and have one combined axial length.

3. The reconfigurable tool according to claim 1 wherein the base body has first and second surfaces that are respectively in confronting relationship with first and second surfaces on the first tool part with the base body and first tool part in the first connected relationship, the confronting first and second surfaces on the base body and first tool part cooperating to limit relative movement between the base body and first tool part around the turning axis.

4. The reconfigurable tool according to claim 1 wherein there is a first rib extending around the turning axis on one of the base body and first tool part and a first groove extending around the turning axis on the other of the base body and first tool part, the first rib and first groove configured to cooperate so as to: a) guide relative movement between the base body and first tool part as the base body and first tool part are changed between the first starting relationship and first connected relationship; and b) key the base body and first tool part in the first connected relationship against relative axial movement.

5. The reconfigurable tool according to claim 1 wherein one of the base body and first tool part has a first discrete projecting part and the other of the base body and first tool part has a first receptacle for the first discrete projecting part, the first discrete projecting part advanced into the first receptacle as an incident of the base body and first tool part being changed from the first starting relationship into the first connected relationship, the first discrete projecting part and first receptacle cooperating, with the base body and first tool part in the first connected relationship, to limit relative movement between the base body and the first tool part at least one of: a) around the turning axis; and b) along the turning axis.

6. The reconfigurable tool according to claim 5 wherein the first receptacle is defined on the base body wall and extends fully through the base body wall, the first tool part is advanced in one radial direction relative to the base body as the base body and first tool part are changed from the first starting relationship into the first connected relationship, and with the base body and first tool part in the first connected relationship a part of the first discrete projection is exposed at an outside surface of the base body wall, thereby allowing a user to exert a force on the part of the first discrete projection and thereby urging the first tool part relative to the base body in a direction oppositely to the one radial direction.

7. The reconfigurable tool according to claim 1 wherein the base body wall extends around an open volume, a slot is formed in the base body wall between the first and second ends of the base body and is contiguous with the open volume, the first tool part has a wall extending around an open volume, a slot is formed on the wall of the first tool part and is contiguous with the open volume of the first tool part, and with the base body and first tool part in the first connected relationship, the slots on the base body and first tool part align so that an elongate conduit, with which a component with the first configuration is associated, can be directed into the open volumes on the base body and first tool part while allowing the first engaging part to be operatively positioned with respect to the component with the first configuration.

8. The reconfigurable tool according to claim 1 wherein the base body and first tool part are configured so that as an incident of the base body and first tool part being changed from the first starting relationship into the first connected relationship at least one of: a) a portion of the first tool part is frictionally captured between spaced first and second regions on the base body; and b) a part of at least one of the base body and first tool part is resiliently deformed to allow a holding surface on the first tool part to move past a holding surface on the base body and into confronting relationship once the base body and first tool part realize the first connected relationship so as to thereby releasably maintain the base body and first tool part in the first connected relationship.

9. The reconfigurable tool according to claim 1 wherein the base body and first tool part are configured so that the base body and first tool part are guided in a predetermined manner from the first starting relationship consistently into the first connected relationship.

10. The reconfigurable tool according to claim 9 wherein the base body and first tool part are changed from the first starting relationship into the first connected relationship and releasably maintained in the first connected relationship as an incident of press fitting a part of the first tool part into a volume bounded by the base body wall.

11. The reconfigurable tool according to claim 9 wherein the base body and first tool part are configured so that the base body and first tool part can be: a) placed in a second starting relationship with the first tool part in radially spaced and axially overlapping relationship with the base body; and b) moved towards each other transversely to the turning axis into a second connected relationship, whereupon with the base body and first tool part in the second connected relationship and the first engaging part on the first tool part operatively positioned with respect to a component with the first configuration, movement of the base body around the turning axis causes the first tool part to turn the component with the first configuration, wherein the base body and first tool part are configured so that the base body and first tool part are guided in a predetermined manner from the second starting relationship consistently into the second connected relationship, the base body and first tool part having different combined axial lengths in the first and second connected relationships.

12. The reconfigurable tool according to claim 1 wherein a second engaging part is at the other of the first and second ends of the first tool part and is configured to be operatively positioned with respect to a component having a second configuration, the base body and first tool part configured so that the base body and first tool part can be: a) placed in another starting relationship with the first tool part in radially spaced and axially overlapping relationship with the base body and with the first tool part axially inverted from an orientation the first tool part has with the base body and first tool part in the first starting relationship; and b) moved towards each other transversely to the turning axis from the another starting relationship into another connected relationship, whereupon with the base body and first tool part in the another connected relationship and the second engaging part on the first tool part operatively positioned with respect to a component with the second configuration, movement of the base body around the turning axis causes the first tool part to turn the component with the second configuration.

13. The reconfigurable tool according to claim 1 wherein the base body has an engaging part fixedly formed thereon and is configured to be operatively positioned with respect to a component with a second configuration to cause the component with the second configuration to turn as the base body is moved around the turning axis.

14. The reconfigurable tool according to claim 12 wherein at one of the ends of the first tool part body an additional engaging part is provided to be operatively positioned with respect to a component with a third configuration.

15. The reconfigurable tool according to claim 1 wherein the first tool part has an exposed surface on which indicia is placed to identify an aspect of the first engaging part.

16. The reconfigurable tool according to claim 1 wherein the base body wall has an outer surface that can be grasped in a user's hand to facilitate manual movement of the base body around the turning axis.

17. The reconfigurable tool according to claim 1 further comprising a second tool part having spaced ends, the second tool part and base body configured so that with the base body and second tool part placed in a first starting relationship, wherein the second tool part is spaced axially from the base body, the base body and second tool part can be moved axially towards and against each other into a first connected relationship wherein the base body and second tool part each follows movement of the other around the turning axis, with the second tool part and base body in their first connected relationship, the second tool part body is at one of the first and second ends of the base body and defines at least one of: a) a connector for a tool usable to apply a force to the second tool part tending to move the second tool part around the turning axis; and b) an engaging part to be operatively positioned with respect to a certain component whereupon movement of the second tool part around the turning axis causes the certain component to turn, wherein with the base body and first tool part in their first connected relationship, the first tool part is at the other of the first and second ends of the base body.

18. The reconfigurable tool according to claim 17 wherein the base body and second tool part are configured so that the base body and second tool part can be placed in a second starting relationship, wherein the second tool part is inverted from an orientation the second tool part has with the base body and second tool part in their first starting relationship and the second tool part is spaced axially from the base body, the base body and second tool part can be moved axially from their second starting relationship towards and against each other into a second, connected relationship wherein the base part and second tool part each follows movement of the other around the turning axis, with the base body and second tool part in their second connected relationship the second tool part body is at the one of the first and second ends of the base body and defines at least one of: a) a connector for a tool usable to apply a force to the second tool part tending to move the second tool part around the turning axis; and b) an engaging part to be operatively positioned with respect to a certain component whereupon moving of the second tool part around the turning axis causes the certain component to turn.

19. The reconfigurable tool according to claim 17 wherein with the base body and second tool part in their first connected relationship, a circumferential outer surface on the second tool part resides within and is in axially overlapping relationship with an inner circumferential surface on the base body and there is a plurality of tabs and tab receptacles that cooperate in circumferentially spaced pairs on the circumferential inner and outer surfaces to cause the base body and second tool part each to follow movement of the other around the turning axis.

20. The reconfigurable tool according to claim 19 wherein the tabs and tab receptacles are configured so that the tabs and tab receptacles cooperate to selectively key the base body and second tool part in different angular relationships, wherein there is an additional engaging part at the one of the first and second ends of the base body configured to be operatively positioned with respect to an additional component with the second tool part separated from the base body so that movement of the base body around the turning axis causes the base body to turn the additional component, the additional engaging part defined at least partially by the tab receptacles.
